(19) United States
(12) Patent Application Publication
(10) Pub. No.: US 2008/0026161 A1
(43) Pub. Date: Jan. 31, 2008

(54) Photocatalytically Active Coating of a Substrate

(76) Inventors: Wolfgang Frings, Kirn (DE); Stefan Sepeur, Wadgassen (DE); Frank Gross, St. Ingbert (DE); Reimund Krechan, Alsweiler (DE); Christoph Weyer, Uberherrn (DE)

Correspondence Address: Millen White Zelano & Branigan;Arlington Courthouse Plaza 1, Suite 1400, 2200 Clarendon Blvd, Arlington, VA, 22201, US

(21) Appl. No.: 10/564,559

(22) PCT Filed: Jul. 15, 2004
(86) PCT No.: PCT/EP04/51514

§ 371 Date: Apr. 16, 2007

(30) Foreign Application Priority Data
Jul. 16, 2003 (EP) 031021942

(51) Int. Cl. B01J 21/06; B01J 35/00; B01J 37/025; B01J 37/34

(52) U.S. Cl. 427/559; 106/286.2

(57) ABSTRACT

The invention relates to a photocatalytically active coating of a substrate, which is composed of a protective layer and photocatalytically active particles that are applied thereto, the protective layer having no photocatalytic activity. The protective layer preferably contains ZrO₂ and SiO₂.

### TECHNICAL SPHERE

The invention relates to a photocatalytically active coating of a substrate, composed of a protective layer and of photocatalytically active particles applied thereto, where the protective layer has no photo-catalytic activity.

The effect of photocatalysis has been known for a long time and is in particular used for the oxidation of substrates in sunlight or in artificial light. By way of example, the oxidation can be utilized in the chemical industry for the controlled oxidation of chemical compounds. However, the main use is found in the non-specific oxidation of nitrogen oxides, of dirt particles, or of substances with unpleasant odor.

A side effect of the photocatalytic activity is that this type of surface is highly hydrophilic. This leads to a very high level of wetting of the surface with water, the result being that dirt particles can be washed off very easily from this type of surface, for example by rainwater. The main application sector for self-cleaning surfaces is provided by glass windows or facade components composed of glass-like materials, since most photocatalytically active materials have sufficient transparency.

Photocatalytically active coatings for the outdoor sector have to have sufficient mechanical and chemical stability. This should not be obtained by sacrificing the activity of the coating; this has to have sufficiently high activity even at a very low level of insolation, e.g. in winter.

Another factor to be considered is that the photo-catalytic activity of a coating acts not merely on the desired substrates but also on the backing material for the coating. In the case of the photocatalytically active glass windows mentioned, this is unimportant because inorganic materials such as glass are inert to oxidation reactions.

EP 0 630 679 B1 discloses the calcining of a TiO₂ sol at relatively high temperatures for production of photocatalytically active coatings. This gives a coherent TiO₂ layer with superposed TiO₂ particles, the photocatalytic layer thus obtained being superposed directly on the backing. This type of coating cannot be used for backing materials that are thermally labile and/or that are easily oxidized.

EP 1 074 525 A1 discloses the use of N-type semiconductor materials as over- and underlayer. Here, charged transfer takes place from the backing material through the underlayer to the photocatalytically active overlayer, and this means that here again it is likely that the backing material is subject to decomposition processes.

EP 0 816 466 A1 describes the use of TiO₂/SiO₂ mixtures as photocatalytically active coating. The SiO₂ content of the mixture is intended to inhibit the photo-catalytic decomposition of the backing material, but at the same time leads to coating of the photocatalytically active TiO₂ particles, i.e. to their deactivation.

Similarly, EP 1 118 385 A1 discloses the production of a two-layer system with a chemically inert underlayer and with a photocatalytically active overlayer. The overlayer comprises a binder material which in turn can lead to partial deactivation of the photocatalytically active particles. Furthermore, a calcining process is carried out to produce the coating and, if the backing materials are thermally labile, can lead to deformation or to changes in the color of the backing.

EP 1 016 458 A1, too, describes a two-stage coating system with a photocatalytically active overlayer and with a substrate-protecting underlayer. The underlayer is composed of an organic-inorganic hybrid polymer, i.e. is derived from covalent bonding of metal oxides and of polymers. However, the polymers can be degraded by oxidation and can be attacked by the photocatalytically active overlayer.

EP 1 066 788 A1 discloses a coating in which the photocatalytically active overlayer comprises not only the actual photocatalyst (TiO₂) but also compounds of metals of transition group V, VI, and VII of the Periodic Table of the Elements, as cocatalyst.

US 2002/45073 A1 describes a process for production of photocatalytically active layers composed of a crystalline phase, preferably TiO₂. For this, an underlayer is first applied to a substrate and either produces or promotes the crystallinity of the overlayer. The crystalline phase of the overlayer is produced in an annealing step at an elevated temperature. Both under- and overlayer are produced via sputtering or CVD in a process which is physical or is not a solution-chemistry process. These processes are too complicated for large substrate surfaces.

DE 101 58 433 A1 discloses the coating of substrates with a primer layer onto which photocatalytically active titanium dioxide particles are applied. The primer layer is intended to serve as a water reservoir and it therefore has a certain porosity. The use of a porous primer layer can, with substrates that are easily oxidized, such as plastics, lead to undesired decomposition phenomena initiated via the photo-catalytic particles.

For binding to the substrate surface, the coatings disclosed in DE 101 58 433 A1 need physico-chemical activation thereof, e.g. via corona discharge. Furthermore, for thermally labile substrates, rapid setting of the layers at very low temperatures is essential. For example, in the coating of window profiles composed of PVC, temperatures above 100° C. lead to deformation which, however, makes accurate fit impossible during further processing of the profile. The reaction conditions disclosed here have only restricted application to accurately dimensioned products.

### OBJECT

It was therefore an object of the present invention to provide photocatalytically active coatings which are suitable even for thermally labile or easily oxidized backing materials.

### BRIEF DESCRIPTION OF THE INVENTION

The present invention provides a photocatalytically active coating of a substrate composed of at least two layers produced by solution chemistry and with at least one first underlayer applied to the substrate and composed of an inorganic polymer and at least one second overlayer composed of TiO₂ particles, where the underlayer comprises less than 0.5% by weight of TiO₂ particles, is pore-free, and comprises at least 5% by weight of ZrO₂.

The inventive underlayer comprises no pores, completely covers the substrate, and thus provides protection of easily oxidized surfaces from photocatalytically initiated decomposition via the overlayer. This is particularly advantageous in the coating of window profiles composed of PVC, because these likewise comprise titanium dioxide. If the titanium dioxide present in the PVC composition were to be released, the result is a further increase in the decomposition rate of the plastic. The thermal hardening of the underlayer can take place at temperatures sufficiently low to prevent any deformation of molded semifinished products, such as profiles.

Furthermore, the underlayer is substantially free from TiO₂ particles. This means that, starting from the substrate, at least 85%, preferably at least 90%, very preferably at least 95%, of the thickness of the underlayer is practically free from TiO₂ particles, i.e. comprise less than 0.5% by weight and in particular less than 0.1% by weight of TiO₂ particles.

The underlayer can be composed of at least two layers applied in succession of identical or different constitution. The provisos for the content of TiO₂ and ZrO₂ apply to the entirety of the sublayers, but can also be formulated for each individual layer. For example, it is possible for one of the layers to be composed entirely of ZrO₂ and for another layer to be composed of a SiO₂/ZrO₂ mixture. The sublayers can also have identical constitution but different thickness, e.g. via application of suspensions of different solids content.

Inventive coatings are therefore particularly suitable for the coating of substrates composed of one or more polymeric materials and/or metals. The polymeric material used can comprise one or more polymers selected from the group of polyvinyl chloride (PVC), polypropylene (PP), polyethylene (PE), polyacrylates and -methacrylates, e.g. polymethyl methacrylate (PMMA), polystyrene (PS), polycarbonate (PC), polyester, epoxy materials, polyurethanes (PU), polyisocyanates, SBR, ABS, ASA, NBR, or copolymers composed of acrylonitrile, styrene, butadiene, methacrylate, or isoprene, in each case in the form of homo- or copolymer, in the form of coextrudate, or in the form of polymer blend.

The substrates may have been previously molded to give semifinished products, if appropriate with complex geometric shapes, e.g. extruded profiles. Clearly, coextrudates can be used here. For example, semifinished PVC products, such as window profiles or door profiles, can be provided with an outer layer composed of the polymers mentioned, in particular PMMA.

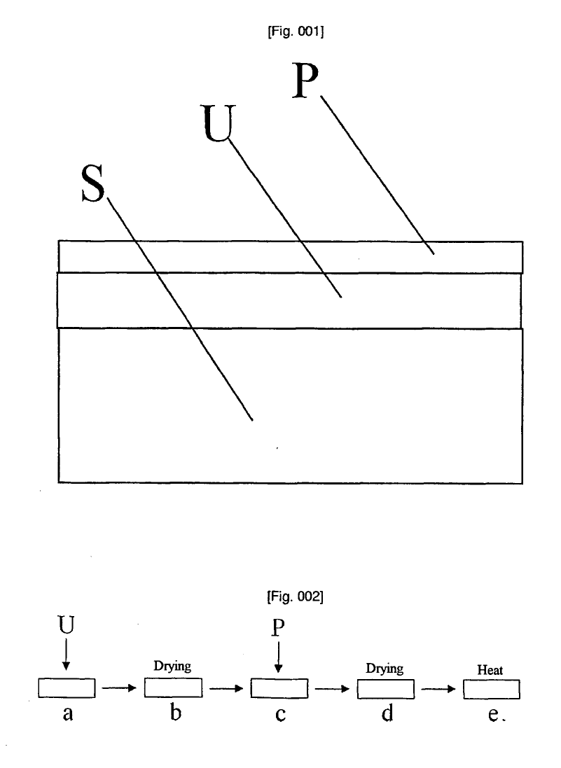

FIG. 1 is a diagram of the structure of an inventive coating, S being substrate, U being chemically inert underlayer composed of the inorganic polymer, and P being the photocatalytically active layer composed of TiO₂ particles.

The thickness of the first layer (U in FIG. 1, under-layer) in the dry, crosslinked state is preferably from 100 to 500 nm, particularly preferably 200 to 500 nm, and in particular from 300 to 500 nm.

The thickness of the second, photocatalytically active layer (P in FIG. 2, overlayer) in the dry state is preferably from 20 to 100 nm, particularly preferably from 20 to 50 nm.

The inorganic polymer of the underlayer(s) is preferably composed of one or more metal oxides covalently bonded to one another from the group of SiO₂, ZrO₂, Al₂O₃, Nb₂O₃, Ta₂O₃, CaO. For the purposes of this invention, a compound which is formally composed of the metal oxides mentioned, prepared, for example, by the sol-gel process of DE 101 58 433 A1, is regarded as an inorganic polymer. This also includes the linkage of relatively large units or blocks, e.g. ZrO₂ particles by way of SiO₂ bridges.

Inorganic polymers which comprise SiO₂ and ZrO₂ in a ratio by weight of from 50:50 to 95:5, in particular from 75:25 to 90:10 or from 85:15 to 90:10, have proven successful as underlayer. Layers of this type can optionally also comprise from 0.01 to 2% by weight (based on the underlayer) of at least one other metal oxide, such as Al₂O₃, Nb₂O₃, Ta₂O₃, or CaO, or else carbon in the form of carbon black.

The diameter of the TiO₂ particles of the photocatalytically active overlayer is preferably from 5 to 30 nm, in particular from 10 to 25 nm; it is advisable to use particles of the anatase crystalline form rather than those of rutile structure.

The photocatalytic activity of the TiO₂ particles may have been reduced via the coating process. In order to reactivate the overlayer, the substrates can be exposed to sunlight or to appropriate artificial UV irradiation for from 1 to 5 hours.

The present invention also provides a process for production of photocatalytically active coatings on a substrate via the following steps of the process

a. coating of a substrate with an inorganic polymer by solution chemistry via application of a suspension of the inorganic polymer or its chemical precursors in an organic suspension medium,

b. complete or partial removal of the organic suspension medium, to give an underlayer.

c. application of a dispersion composed of TiO₂ particles in an organic dispersion medium to the underlayer.

d. complete or partial removal of the organic dispersion medium to give an overlayer.

e. heat-treatment of the under- and overlayer at from 20 to 120° C. for from 10 to 300 sec, with the proviso that the underlayer comprises less than 0.5% by weight of TiO₂ particles, is pore-free, and comprises at least 5% by weight of ZrO₂.

### Step a of the Process

The suspension used in step a) of the process comprises the inorganic polymer or its chemical precursors. Chemical precursors are compounds from which the inorganic polymers or the metal oxides mentioned can be prepared, in particular one or more metal oxides from the group of SiO₂, ZrO₂, Al₂O₃, Nb₂O₃, Ta₂O₃, CaO, and/or the corresponding alkoxides, chlorides, nitrates, hydroxides, formates, or acetates, in each case individually or in the form of a mixture.

Particularly suitable starting materials for SiO₂ are silica sol, silica gel, and/or silicic acid, organo-silanes, such as alkoxy- or alkoxyhydroxysilanes, and in particular tetraalkoxysilanes; and for ZrO₂: the zirconium alkoxides, e.g. zirconium butanolate or zirconium propanolate. The use of other metal oxides, e.g. Al₂O₃, if appropriate in the form of aluminum-oxide-doped SiO₂, is optional.

The solids content of the suspensions in step a) of the process can be from 0.1 to 25% by weight, preferred solids contents for obtaining a homogeneous layer here being from 1 to 5% by weight.

One particular variant of the invention uses a suspension whose solids content is from 1 to 5% by weight, composed of 50, 75, 85, 90, or 95% by weight of SiO₂ (or of an appropriate chemical precursor) and the appropriate 50, 25, 15, 10, or 5% by weight of ZrO₂ (or of an appropriate chemical precursor). The SiO₂ content is in turn preferably composed of a silica sol whose particle diameter is from about 5 to 50 nm and of an organosilane as precursor, preferably tetraalkoxysilane, in a silane/silica sol ratio of from 50:50 to 20:80% by weight, based on the SiO₂ solid. The ZrO₂ content is preferably used in the form of a zirconium alkoxide, and preferably in turn here in the form of the propanolate or butanolate.

A suitable organic suspension medium comprises alcohols, such as ethanol, propanol, isopropanol, isobutanol, n-butanol, water, formic acid, and/or acetic acid, alone or in the form of a mixture, and to these is added a wetting agent of relatively high boiling point (from 100 to 200° C.), e.g. alkyl glycols or glycol and in particular here ethylene glycol, propylene glycol, or butylene glycol, alone or in the form of a mixture. Alcohols such as isopropanol or n-butanol are also suitable as wetting agent. In order to avoid precipitation reactions, the pH of the suspension is adjusted to about 3.5, using formic acid or acetic acid.

The wetting agent is particularly required in the coating of substrates that are polymeric and also hydrophobic, in order to permit their complete and pore-free covering with the suspension, i.e. the underlayer and, respectively, dispersion of the overlayer. The content of the wetting agent is preferably from 2 to 10% by weight of the dispersion or suspension. The wetting agent can also comprise ionic or non-ionic surfactants; amounts of from 0.01% to 0.5% by weight have proven successful, based on the suspension/dispersion.

Suitable means are used to apply the suspension to the substrate surface. The method here can be spreading or dipping, and spraying methods have proven to be particularly efficient. The wet layer thickness is from about 10 to 100 μm. Particularly in the case of substrates with complex surface structures, e.g. window profiles, spray techniques have proven successful, if appropriate using two or more spray heads in different geometrical arrangements.

### Step b of the Process

The underlayer applied in step a) of the process is predried to give a moist layer. For this, the alcohol component of the suspension is completely or partially removed. Because the boiling point is low, this can be achieved at from 20 to 40° C., preferably at room temperature, thus requiring practically no further heat treatment. The sole requirement is suitable extraction or reclamation of the alcohol vapors.

### Step c of the Process

The TiO₂-containing dispersion is preferably composed of the abovementioned organic suspension media (here termed dispersion media), and of wetting agents and/or of surfactants, its solids content preferably being from about 0.1 to 2.5% by weight, in particular from 0.1 to 1% by weight, of TiO₂ particles. The TiO₂ particles are preferably used in the anatase crystalline form, their diameter being in particular from about 5 to 25 nm.

The abovementioned spray equipment has also proven successful in this step of the process. The application of the photocatalytically active layer to the underlayer, which remains moist, has to take place in such a way as to give firm adhesion of the TiO₂ particles to the underlayer, but practically no mixing of the layers. The wet layer thickness is from about 5 to 30 μm.

### Step d of the Process

This step of the process is the same as step c) in the production of the underlayer and is preferably carried out at room temperature with extraction of the alcohol components.

### Step e of the Process

The heat-treatment and with this the fixing of the layers then takes place at temperatures of from 20 to 120° C., preferably from 20 to 100° C., particularly preferably from 50 to 80° C. In specific cases, heat-treatment at from 100 to 120° C. can be indicated. The heat-treatment time depends on the temperature applied, and can be up to 300 sec. at low temperatures. Heat-treatment for from about 30 to 60 sec. is preferred. The heat-treatment is preferably carried out using IR sources, microwave generators, or lasers, because here only superficial heating of the substrate to be coated takes place.

Step a) to e) of the process can proceed continuously in a manner similar to that of FIG. 2. The labels a to e in FIG. 2 correspond to steps a) to e) of the process, the underlayer U being applied in the steps a) and the overlayer P being applied in the steps c). By using suitable conveyor belts or the like it is possible for each of the steps a) and c) and, respectively, b) and d) of the process to be carried out in shared equipment.

One variant of the inventive process applies the underlayer in two or more steps to the substrate, i.e. steps a) and b) of the process are carried out at least twice in succession.

Similarly, the overlayer can be applied to the substrate in two or more steps, i.e. steps c) and d) of the process are carried out at least twice in succession.

A method which has proven successful here uses suspensions with identical constitution but different solids content in the individual operations. For example, it is possible for a first layer to be applied using a suspension whose solids content is 1% by weight and for the following layer to be applied using a suspension whose solids content is 5% by weight. Specifically in the case of hydrophobic substrates, such as PVC, this procedure can give an underlayer which has good adhesion, is homogeneous, and is pore-and crack-free.

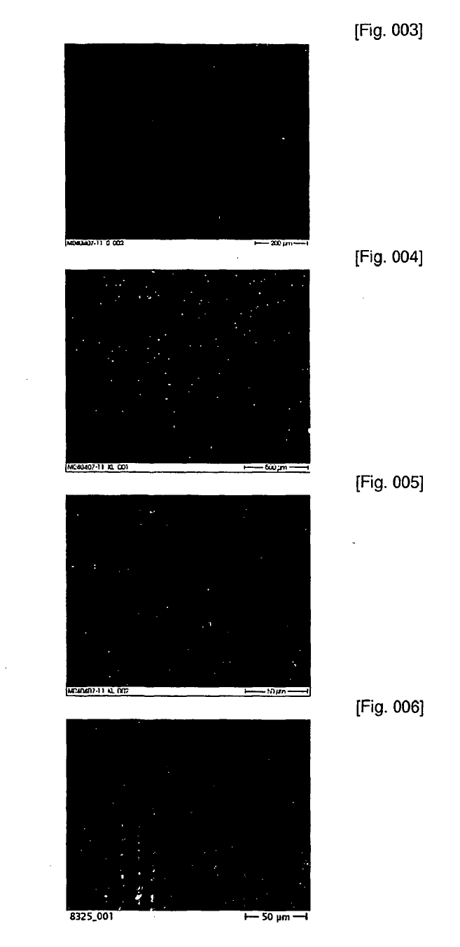

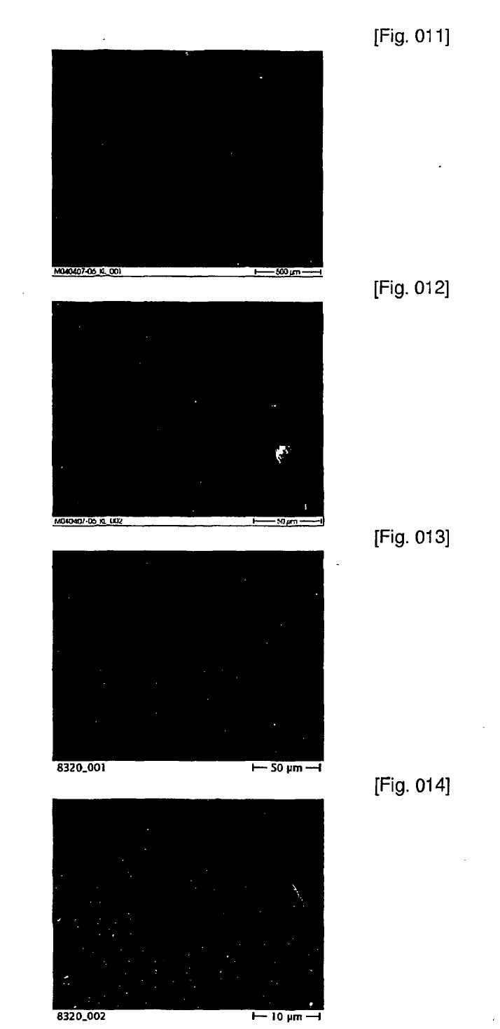

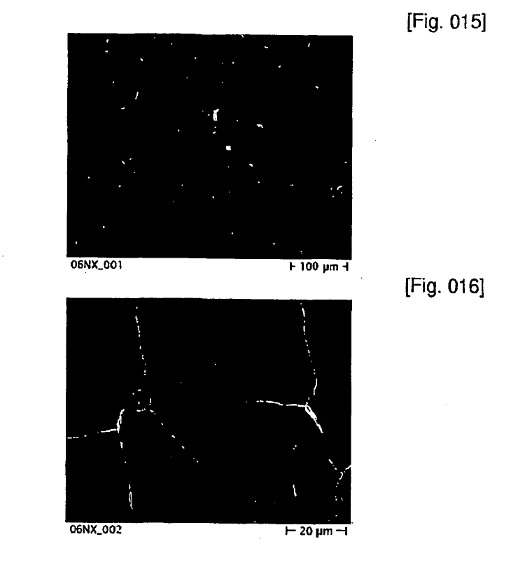

FIGS. 3-16 show scanning electron micrographs of the surfaces of PVC substrates, of freshly applied underlayers, and of underlayers tested for their stability in a XENO cabinet or controlled-temperature-and -humidity cabinet.

TABLE 1

| Figure | Surface | Weathering |
|---|---|---|
| 3 | Uncoated PVC | None |
| 4 | 25 nm of SiO₂ particles | None |
| 5 | 25 nm of SiO₂ particles | None |
| 6 | 25 nm of SiO₂ particles | XENO |
| 7 | 25 nm of SiO₂ particles | XENO |
| 8 | 25 nm of SiO₂ particles | Controlled-temperature- |
| | | and -humidity cabinet |
| 9 | 25 nm of SiO₂ particles | Controlled-temperature- |
| | | and -humidity cabinet |
| 10 | Uncoated PVC | None |
| 11 | 15 nm of SiO₂ particles | None |
| 12 | 15 nm of SiO₂ particles | None |
| 13 | 15 nm of SiO₂ particles | XENO |
| 14 | 15 nm of SiO₂ particles | XENO |
| 15 | 15 nm of SiO₂ particles | Controlled-temperature- |
| | | and -humidity cabinet |
| 16 | 15 nm of SiO₂ particles | Controlled-temperature- |
| | | and -humidity cabinet |

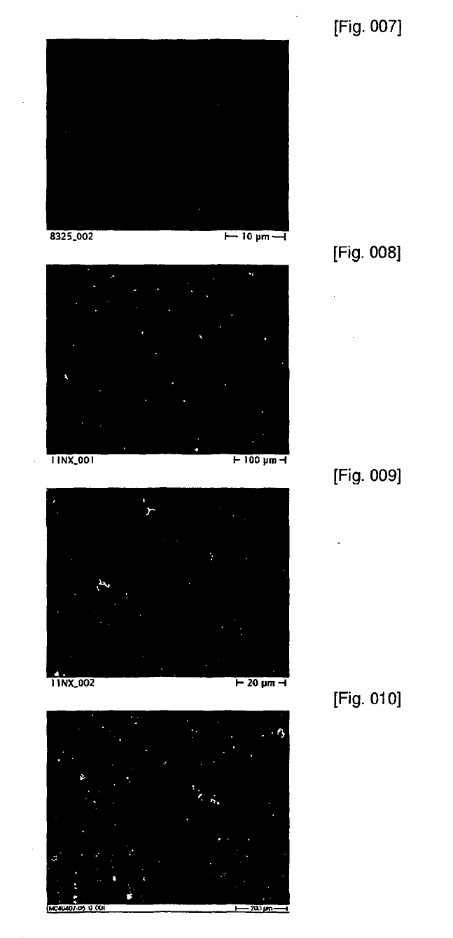

The usual pore structure of PVC (FIG. 3) has been sealed via the coating. Some natural stress cracks are produced via different degrees of expansion of layer and substrate. This coherent surface is retained even after artificial weathering, such as frost and heat, and also exposure to UV. UV radiation of unnatural intensity (XENO lamp) also brings about thermal effects in PVC, and this leads to an increasing amount of stress cracking. The adhesion of the layer to the substrate is, however, retained, as shown by FIG. 7.

FIGS. 3-16 show that the inventive underlayers adhere to the substrate even after the extreme weathering of the test, and represent a layer providing protection from photocatalytic oxidation with respect to the overlayer.

The invention also provides window profiles, door profiles, roller-shutter segments, window sills, architectural panels, door leaves, gutters, downpipes, or plastics or aluminum shells for the covering of window or door frames, with the coating mentioned.

These are articles often produced from PVC, with or without other polymers, fillers, or additives. The semifinished products are advantageously produced in the traditional way, e.g. window profiles or door profiles via extrusion. These semifinished products are then coated according to the invention and are then assembled in the traditional way to give the finished article (window frame).

When prefabricated semifinished products composed of polymeric materials are coated, possible deformation of the articles during the drying steps b) and/or d) has to be considered. The substrates to be coated can optionally be preheated to a temperature below the Vicat softening point of the substrate prior to step a) of the process. In the case of PVC-containing substrates, such as window profiles, a preheating temperature of from 35 to 65° C. has proven successful. All that is then necessary during the drying steps b) and/or d) in this variant of the process is a very small temperature increase, thus substantially eliminating any deformation of the article. As an alternative, once steps a) to e) of the process have been completed, the substrate can be subjected to annealing at the temperature mentioned or to calibration.

Particular reference is made to the disclosure of DE 10 002 658 A1 for the application in window/door construction. Here, a profile system for production of window frames or of door frames composed of plastic is described, these having a cladding of an aluminum shell or of a plastics shell. The aluminum shells can be coated with plastics coverings, in particular here powder coatings based on epoxide, on polyester, or on PVC, in almost any desired colors. The plastics-coated aluminum shells can likewise be coated according to the invention.

The present invention therefore also provides painted or unpainted aluminum shells optionally coated using the plastics mentioned and intended for cladding of window frames or door frames composed of plastic using the photocatalytically active coating described above and, respectively, using the processes described.

The materials thus rendered photocatalytic have a highly hydrophilic surface and are particularly easy to clean. If these materials are used in the outdoor sector and are exposed to insolation and rain, self-cleaning occurs, because dirt can be oxidatively attacked by the photocatalytically active surface and can easily be washed off by rain.

### EXAMPLES

### Underlayer, Variant 1

20.8 g of tetraethoxysilane, 1.2 g of zirconium butanolate, and 20 g of isopropanol are treated with 10.0 g of 0.1% strength hydrochloric acid, with stirring, and stirred for one hour at room temperature. The clear solution is then diluted with 89.4 g of water. 0.2 g of Byk 348 is added as surfactant to improve flow.

### Overlayer, Variant 1

10.0 g of Disperal P25 titanium dioxide (Degussa) and 0.1 g of Genapol UD 050 non-ionic surfactant are used as initial charge in 90.0 g of 1% strength formic acid. The mixture is dispersed for 20 min at 16000 rpm, using a Turrax. The white suspension is then diluted with 900.0 g of water, with high-speed stirring, giving a homogeneous milky solution.

### Underlayer, Variant 2

20.8 g of tetraethoxysilane, 1.2 g of zirconium butanolate, and 20 g of isopropanol are treated with 10.0 g of 0.1% strength hydrochloric acid, with stirring, and stirred for one hour at room temperature. The clear solution is then diluted with 89.4 g of isopropanol.

### Overlayer, Variant 2

28.4 g (0.10 mol) of titanium isopropanolate are dissolved in 170 g of isopropanol and treated with 0.4 g of 2M hydrochloric acid, with stirring. The solution is stirred for one hour at room temperature. 1% strength acetic acid is then poured slowly into the clear solution, with high-speed stirring, and the mixture is then allowed to stand for 30 min. The solution is then charged to an autoclave, slowly heated to 200° C., and kept at this temperature for 8 h. The mixture is then allowed to cool slowly at room temperature.

### Coating

A prefabricated window profile composed of PVC from profine GmbH was first cleaned with isopropanol and dried. The suspension of the underlayer was then spray-applied, using a wet-film thickness of about 30 μm, and was subjected to 30 sec. of a drying process at room temperature. A thickness of about 10 μm of the dispersion of the overlayer is misted onto the underlayer. Stationary compressed-air spray guns were used for spray-application of the two layers, the profile being passed at constant velocity under the spray guns. After brief dry-off of the overlayer at room temperature (about 30 sec.), the coating was thermally crosslinked at about 80° C. for about 60 sec. by means of an IR source of length about 1 m placed parallel to the profile. Here again, the profile was passed under the source with constant velocity, so that the average conditions under which every part of the surface was heated comprised the specified temperature for the specified period.

In both cases, this gave a photocatalytically active and scratch-resistant coating on the profiles.

1. A photocatalytically active coating of a substrate composed of at least two layers produced by solution chemistry and with at least one first underlayer applied to the substrate and composed of an inorganic polymer, and comprising the metal oxides SiO₂ and ZrO₂ covalently bonded to one another, and at least one second overlayer composed of TiO₂ particles, characterized in that the underlayer comprises less than 0.5% by weight of TiO₂ particles, is pore-free, and comprises SiO₂ and ZrO₂ in a ratio by weight of from 50:50 to 95:5.

2. The photocatalytically active coating as claimed in claim 1, characterized in that the inorganic polymer is composed of one or more metal oxides covalently bonded to one another from the group of SiO₂, ZrO₂, AL₂O₃, Nb₂O₃, Ta₂Q₃, CaO.

3. The photocatalytically active coating as claimed in claim 1 characterized in that the underlayer is composed of at least two layers applied in succession of identical or different constitution.

4. The photocatalytically active coating as claimed in claim 1, characterized in that the substrate used comprises one or more polymers selected from the group of PVC, PP, PE, PMMA, PS, PC, polyesters, epoxy materials, polyurethanes, polyisocyanates, SBR, ABS, ASA, NBR, or copolymers composed of acrylonitrile, styrene, butadiene, methacrylate, or isoprene, in each case in the form of homo- or copolymer, in the form of coextrudate, or in the form of polymer blend.

5. A process for production of photocatalytically active coatings on a substrate, characterized by the following steps of the process:
a. coating of a substrate with an inorganic polymer by solution chemistry via application of a suspension of the inorganic polymer or its chemical precursors in an organic suspension medium,
b. complete or partial removal of the organic suspension medium, to give an underlayer.
c. application of a dispersion composed of TiO₂ particles in an organic dispersion medium to the underlayer.
d. complete or partial removal of the organic dispersion medium to give an overlayer.
e. heat-treatment of the under- and overlayer at from 20 to 120° C. for from 10 to 300 sec, with the proviso that the underlayer is composed of an inorganic polymer, comprises less than 0.5% of TiO₂ particles, is pore-free, and comprises SiO₂ and ZrO₂ in a ratio by weight of from 50:50 to 95:5.

6. The process as claimed in claim 5, characterized in that the suspension used in step a) of the process comprises the metal oxides SiO₂ and ZrO₂, and also optionally Al₂O₃, Nb₂O₃, Ta₂O₃, CaO, and/or the corresponding alkoxides, chlorides, nitrates, hydroxides, formates, or acetates.

7. The process as claimed in claim 5, characterized in that the organic suspension and dispersion medium comprises ethanol, propanol, isopropanol, isobutanol, n-butanol, glycol, ethylene glycol, propylene glycol, butylene glycol, water, formic acid, and/or acetic acid, alone or in the form of a mixture.

8. The process as claimed in claim 6, characterized in that steps a) and b) of the process are carried out at least twice in succession.

9. The process as claimed in claim 6, characterized in that steps c) and d) of the process are carried out at least twice in succession.

10. A window profile, a door profile, a roller-shutter segment, a window sill, an architectural panel, a door leaf, a gutter, a downpipe, or a plastics or aluminum shell for the covering of window or door frames, with a coating as claimed in claim 1.
